(19) United States
(12) Patent Application Publication
(10) Pub. No.: US 2010/0181247 A1
(43) Pub. Date: Jul. 22, 2010

(54) Dewatering belt for flue gas desulphurisation installations, of a single-layered fabric belt

(76) Inventors: Frank Esser, Dueren (DE); Kurt Sullot, Nettetal (DE)

Correspondence Address: COLLARD & ROE, P.C., 1077 NORTHERN BOULEVARD, ROSLYN, NY, 11576, US

(21) Appl. No.: 12/657,240

(22) Filed: Jan. 15, 2010

Related U.S. Application Data
(60) Provisional application No. 61/205,489, filed on Jan. 21, 2009.

(51) Int. Cl. B01D 33/04

(52) U.S. Cl. 210/400

(57) ABSTRACT

A dewatering belt for flue gas desulphurisation installations consists of a single-layered fabric, in which the warp and weft are respectively formed from monofil threads and in which the diameter of the thread type of the weft is greater than the diameter of the thread type of the warp.

The invention relates to a dewatering belt for flue gas desulphurisation installations.

In flue gas desulphurisation installations, the flue gas arrives from the dust filter into an absorber tower, in which a gypsum suspension occurs. This gypsum suspension runs over a hydrocyclone to a vacuum belt. The gypsum suspension is washed on the vacuum belt by the addition of washing water, and the gypsum is separated from the water.

For this special washing process, 1.7 to 3.5 m wide filtration belts are used, which are matched precisely to the process.

Generally, multi-layered fabric belts are used for this, in which multifil threads provide for a good filtration performance, whilst monofil threads increase the stability of the filter belt. In the fabric construction, attention is always to be paid to the fact that multifil threads generally bring about a good filtration performance but a poor stability. Also, fine monofil threads lead to an adequate filtration performance, but here also the problem of a limited stability arises. Therefore, multi-layered fabrics have established themselves, in which an optimum of filtration performance and stability can be achieved in different fabric layers through the combination of monofil and multifil threads.

The invention is based on the problem of further developing a dewatering belt for flue gas desulphurisation installations.

This problem is solved by a dewatering belt of single-layered fabric belt, in which warp and weft are respectively formed by monofil threads and the diameter of the thread type of the weft is greater than the diameter of the thread type of the warp.

Fortunately, it has been found that also with a single-layered fabric belt of monofil threads, excellent filtration performances were able to be achieved, without the stability of the fabric having suffered hereby.

Through the single-layered fabric, in which respectively only one warp- and one weft thread system is present, a favourable fabric type was able to be provided, which is able to be produced at a favourable cost and is able to be cleaned easily. In particular the use of monofil threads increases the filtration performance, whilst the choice of the diameters is likewise coordinated with a suitable fabric stability and optimum filtration characteristics.

With regard to production technology, it is advantageous if only one thread type forms the warp and another thread type forms the weft.

It has been found in tests that it is advantageous when the diameter of the thread type of the weft is at least twice as great as the diameter of the thread type of the warp. It is particularly advantageous when the diameter of the thread type of the weft is at least three times as great as the diameter of the thread type of the warp.

In order to achieve a sufficient stability, it is proposed that the diameter of the thread type of the weft is greater than 0.5 mm.

In particular for a suitable filtration performance, it is proposed that the diameter of the thread type of the warp is less than 0.35 mm and particularly preferably less than 0.25 mm.

For a dewatering belt which is able to be produced at a favourable cost, it is proposed that the thread type of warp and weft is produced from synthetics. For such synthetic fabrics, for example a thread of a polyester can be used.

An alternative is formed by a dewatering belt, in which the thread type of warp and weft is made from metal.

Particularly good results were also achieved with a dewatering belt, in which the thread type of the warp is made from metal and that of the weft is made from synthetics.

For the interweaving, as an advantageous variant embodiment it is proposed that the warp and weft are interwoven by a twill weave.

The attached figure shows an example embodiment for a gypsum washing belt and the area of use of such washing belts in flue gas desulphurisation installations.

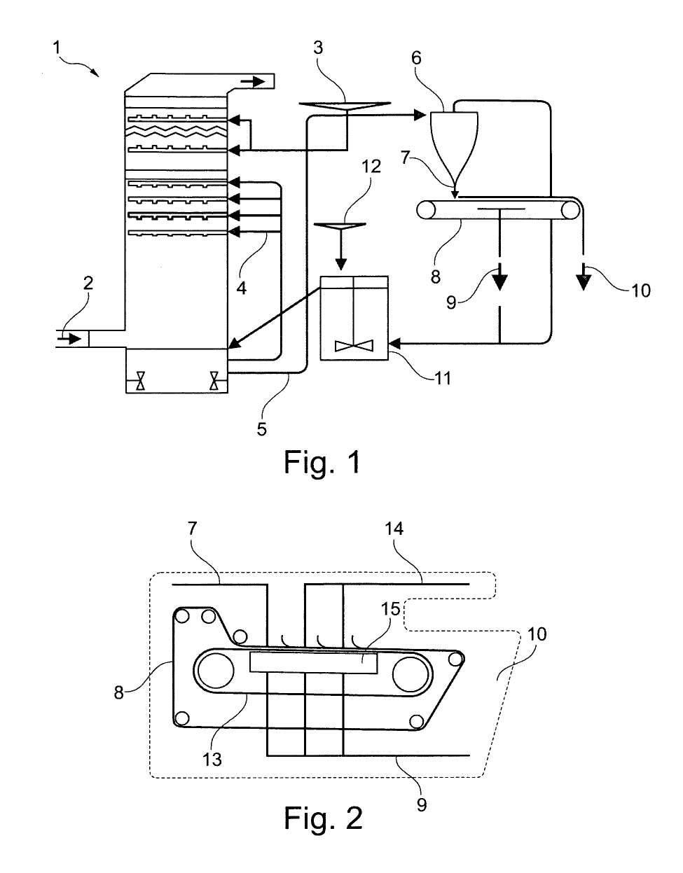

FIG. 1 shows a process diagram for the treatment of flue gas,

FIG. 2 shows a process diagram for the washing of the gypsum suspension,

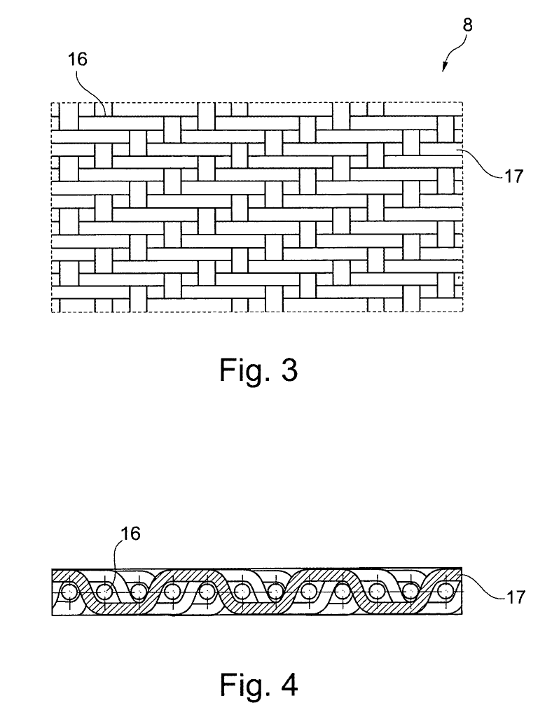

FIG. 3 shows a top view onto a dewatering belt and

FIG. 4 shows a side view of the dewatering belt shown in FIG. 3.

FIG. 1 shows an absorber tower 1, to which flue gas, indicated by the arrow 2, is supplied from a dust filter. In the absorber tower 1, the flue gas 2 is treated with process water 3 and lime solution 4. In so doing, a gypsum suspension 5 occurs, which is supplied to a hydrocyclone 6. The solids content 7 from the hydrocyclone 6 is passed to a revolving belt 8 for washing and dewatering. The belt 8 separates the filtrate 9 from gypsum 10. The gypsum 10 serves as base material for the production of gypsum plasterboards and the filtrate 9 is directed into a gypsum suspension container 11. After the addition of limestone 12, the suspension arrives into the absorber tower 1 again.

The processes on the revolving belt 8 are illustrated further in FIG. 1. The revolving dewatering belt 8, onto which the gypsum suspension 7 from the hydrocyclone 6 and washing water 14 is applied, lies on a support belt 13. Under the dewatering belt 8 and the support belt 13, a suction arrangement 15 lies, via which filtrate 9 is drawn off, whilst gypsum 10 collects on the dewatering belt 8.

FIG. 3 shows such a dewatering belt 8 which has warp threads 16 illustrated vertically in the drawing and weft threads 17 illustrated horizontally in the drawing. Through the twill weave of warp threads 16 and weft threads 17, which can be seen particularly clearly in FIG. 4, a single-layered fabric belt 8 is produced. Here, the warp threads 16 and the weft threads 17 are formed respectively from monofil threads.

FIGS. 3 and 4 are only diagrammatic illustrations. The diameter of the thread type of the weft 17 is approximately three times as great as the diameter of the thread type of the warp 16. In the example embodiment, the diameter of the thread type of the weft is 0.65 mm and the diameter of the thread type of the warp is 0.20 mm. Here, for the warp a monofil metal thread, i.e. a wire, is used, and for the weft a monofil thread of a synthetic polymer is used. A synthetic material such as, for example, a polyester is particularly suited.

1. Dewatering belt for flue gas desulphurisation installations of a single-layered fabric belt, in which the warp and weft are respectively formed from monofil threads and the diameter of the thread type of the weft is greater than the diameter of the thread type of the warp.

2. Dewatering belt according to claim 1, wherein only one thread type forms the warp and another thread type forms the weft.

3. Dewatering belt according to claim 1, wherein the diameter of the thread type of the weft is at least twice as great as the diameter of the thread type of the warp.

4. Dewatering belt according to claim 1, wherein the diameter of the thread type of the weft is at least three times as great as the diameter of the thread type of the warp.

5. Dewatering belt according to claim 1, wherein the diameter of the thread type of the weft is greater than 0.5 mm.

6. Dewatering belt according to claim 1, wherein the diameter of the thread type of the warp is less than 0.35 mm.

7. Dewatering belt according to claim 1, wherein the diameter of the thread type of the warp is less than 0.25 mm.

8. Dewatering belt according to claim 1, wherein the thread type of warp and weft is made from synthetics.

9. Dewatering belt according to claim 1, wherein the thread type of warp and weft is made from metal.

10. Dewatering belt according to claim 1, wherein the thread type of the warp is made from metal and that of the weft is made from synthetics.

11. Dewatering belt according to claim 1, wherein the warp and weft are interwoven by a twill weave.
